(19) United States
(12) Patent Application Publication
(10) Pub. No.: US 2003/0164609 A1
(43) Pub. Date: Sep. 4, 2003

(54) Steering unit for an industrial truck

(76) Inventors: Hans-Jorg Kettenburg, Hamburg (DE); Ulf Logemann, Brackel (DE)

Correspondence Address: William H. Logsdon, WEBB ZIESENHEIM LOGSDON ORKIN & HANSON, P.C., 700 Koppers Building, 436 Seventh Avenue, Pittsburgh, PA, 15219-1818, US

(21) Appl. No.: 10/334,677

(22) Filed: Dec. 30, 2002

(30) Foreign Application Priority Data
Jan. 18, 2002 (DE) 102 01 831.6

(51) Int. Cl. B62D 1/16

(52) U.S. Cl. 280/779

(57) ABSTRACT

A steering unit for an industrial truck includes a steering actuator element fastened by a steering column (2) to a frame (1) of the industrial truck. A joint element makes it possible for the steering column (2) to pivot relative to the frame (1) of the industrial truck and a damping element reduces the transmission of vibrations from the frame (1) of the industrial truck to the steering column (2). At least one bearing component (5) is provided which forms the joint element and the damping element simultaneously. The bearing component (5) includes an elastic, e.g., elastomeric, element.

### CROSS REFERENCE TO RELATED APPLICATION

This application corresponds to German Application No. 102 01 831.6, filed Jan. 18, 2002, which is herein incorporated by reference in its entirety.

### BACKGROUND OF THE INVENTION

1. Field of the Invention

This invention relates generally to industrial trucks and, more particularly, to a steering unit for an industrial truck with a steering actuator element fastened by means of a steering column to a frame of the industrial truck. A joint element is provided which makes possible a pivoting of the steering column relative to the frame of the industrial truck. A damping element reduces the transmission of vibrations from the frame of the industrial truck to the steering column.

2. Technical Considerations

Steering columns of the above type are frequently used in industrial trucks and other utility vehicles. As a result of the ability to tilt the steering column, which is made possible by the joint element, the operator can adjust the position and orientation of the steering actuator element, which is generally in the form of a steering wheel, to meet his or her personal requirements. The steering wheel can then be fixed by means of a locking screw, for example, in the inclined position selected by the operator. The damping element prevents vibrations, for example, of the type that can be caused by a drive motor, from being transmitted to an unpleasant degree to the steering wheel. In addition to the steering wheel, additional shell or casing elements and additional control elements or display elements can also be located on the steering column. Also located on the steering column can be, for example, a hydraulic steering valve or an electrical steering sensor, with which the position or movements of the steering wheel are detected and transmitted in the form of a hydraulic or electrical signal. The joint element and the damping element can be connected with the frame or with the steering column either directly or indirectly by means of components located between them.

In one construction of the prior art, the joint element is realized in the form of a metal hinge joint, with a first part of the hinge joint connected with the frame. The damping element is located on the second part of the hinge joint, which can rotate relative to the first part. The steering column is in turn fastened to the damping element.

It is an object of this invention to provide a steering unit which can be manufactured with a reduced number of parts and which requires less time, effort, and expense for assembly and installation than known steering units.

### SUMMARY OF THE INVENTION

The invention teaches that in one embodiment at least one bearing component is provided which simultaneously forms the hinge element and the damping element. The bearing component thereby performs the functions of vibration damping and providing a movable mounting in a single component.

It is particularly advantageous if the bearing component has an elastic, e.g., elastomeric, element. The elastic, e.g., elastomeric, element can be thereby used to damp the steering column with respect to vibrations of the frame.

On the other hand, the elastic, e.g., elastomeric, element can be located so that it is deformed when there is a pivoting of the steering column. The extent of the deformation thereby always remains within the elastic range.

The elastic, e.g., elastomeric, element of the bearing component can be connected with the frame of the industrial truck on one hand and with the steering column on the other hand. The connections can thereby be realized directly or indirectly by means of components located in between the elastic element and the frame and/or the steering column.

Undesirable movements of the steering column can be prevented if, associated with the steering column, there are two bearing components at a spaced distance from each other. As a result of this arrangement, and in spite of the elastic mounting, a lateral tilting of the steering column is prevented.

Additional advantages and details of the invention are explained in greater detail below with reference to the exemplary embodiment illustrated in the accompanying drawing figures.

### BRIEF DESCRIPTION OF THE DRAWINGS

FIG. 1 is a side view of a steering unit incorporating features of the invention; and

FIG. 2 is a front view of the steering unit of FIG. 1, with portions of the industrial truck removed for ease of consideration.

### DESCRIPTION OF THE PREFERRED EMBODIMENT

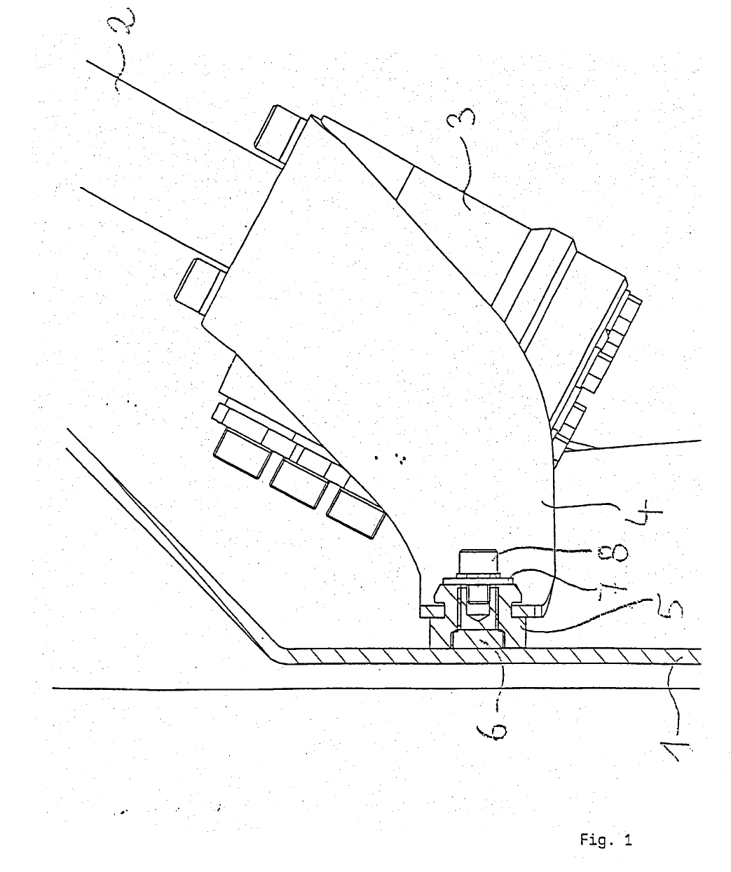

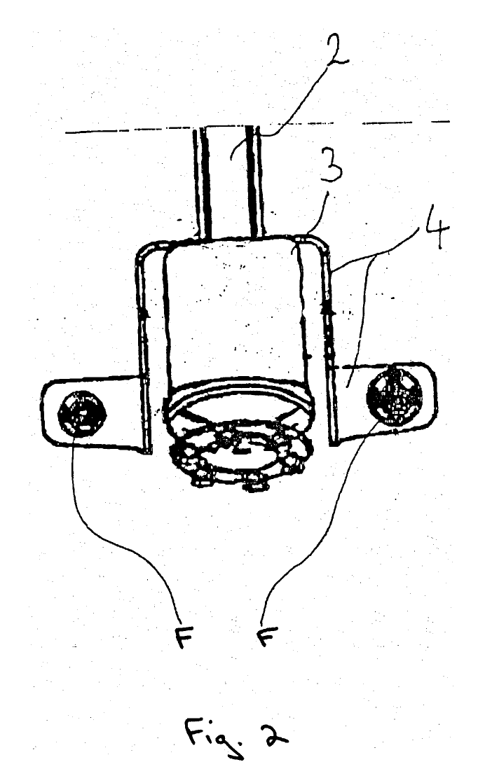

FIGS. 1 and 2 show a drawing of a steering unit of the invention in the vicinity of the fastening to the frame 1 of an industrial truck. The figures show a steering column 2, to the upper end of which a steering actuator element in the form of a steering wheel (not shown) can be rotationally fastened. In this exemplary embodiment, on the lower end of the steering column there is a hydraulic steering valve 3, by means of which the rotational movement of the steering wheel can be transformed into a hydraulic signal. The steering column 2 is connected with the frame 1 by means of a curved retaining plate 4, an elastic, e.g., elastomeric, bearing component 5, and a bolt or pin 6 that is welded to the frame 1. The retaining plate 4 in this case can have a circular cut-out, the edge of which can be locked in a groove on the elastic, e.g., elastomeric, bearing component 5. The bearing component 5 is in turn slipped over the pin 6 that is rigidly connected with the frame. The connection of the bearing component 5 with the pin 6 and the retaining plate 4 with the bearing component 5 can be secured by means of a washer 7 and a screw 8 that is screwed into a female thread of the pin 6.

The elastic, e.g., elastomeric, bearing component 5 makes it possible for the steering column 2 to pivot around an axle that stands perpendicular to the plane of the drawing figure. The relative movement that occurs between the retaining plate 4 and the pin 6 is compensated by the elastic deformation of the bearing component 5. The bearing component 5 thus performs the function of a joint element.

The bearing component 5, on account of its elastic, or elastomeric properties, can have the function of a damping element with respect to vibrations of the frame 1. Because there is no direct mechanical connection between the frame 1 and the retaining plate 4, vibrations are transmitted to the retaining plate 4 of the steering column 2 only to a small degree.

In one non-limiting embodiment, there are a total of two fastening points F for the retaining plate 4 on the frame 1. The fastening points F can be identical and each can have a pin 6, a bearing component 5, a washer 7 and a screw 8. The fastening points F can be at some spaced distance from each other in a horizontal direction, as shown in FIG. 2. The distance between the fastening points F can be approximately 30 centimeters. It is thereby guaranteed that the pivoting capability of the steering column is negligibly small on account of the elasticity of the bearing components 5 around an axis that is oriented parallel to the plane of the drawing. Examples of materials for the elastic component 5 include, but are not limited to, natural or synthetic elastomers, such as but not limited to rubber or neoprene.

It will be readily appreciated by those skilled in the art that modifications may be made to the invention without departing from the concepts disclosed in the foregoing description. Accordingly, the particular embodiments described in detail herein are illustrative only and are not limiting to the scope of the invention, which is to be given the full breadth of the appended claims and any and all equivalents thereof.

What is claimed is:

1. A steering unit for an industrial truck, comprising:
a steering actuator element fastened by a steering column to a frame of the industrial truck;
a joint element configured to allow the steering column to pivot relative to the frame of the industrial truck;
a steering element to reduce transmission of vibrations from the frame of the industrial truck to the steering column; and
at least one bearing component that forms the joint element and the damping element simultaneously.

2. The steering unit as claimed in claim 1, wherein the bearing component includes an elastomeric element.

3. The steering unit as claimed in claim 2, wherein the elastomeric element is oriented such that it is deformed when there is a pivoting of the steering colum.

4. The steering unit as claimed in claim 2, wherein the elastomeric element of the bearing component is connected to the frame of the industrial truck and with the steering column.

5. The steering unit as claimed in claim 1, wherein the steering column includes two bearing components which are at a spaced distance from each other.

6. The steering unit as claimed in claim 3, wherein the elastomeric element of the bearing component is connected to the frame of the industrial truck and with the steering column.

7. The steering unit as claimed in claim 2, wherein the steering column includes two bearing components which are at a spaced distance from each other.

8. The steering unit as claimed in claim 3, wherein the steering column includes two bearing components which are at a spaced distance from each other.

9. The steering unit as claimed in claim 4, wherein the steering column includes two bearing components which are at a spaced distance from each other.

10. The steering unit as claimed in claim 6, wherein the steering column includes two bearing components which are at a spaced distance from each other.
